(19) United States
(12) Patent Application Publication
(10) Pub. No.: US 2012/0233114 A1
(43) Pub. Date: Sep. 13, 2012

(54) MONITORING ORGANIZATIONAL INFORMATION FOR FAST DECISION MAKING

(76) Inventor: Michael Locherer, Seattle, WA (US)

(21) Appl. No.: 13/480,409

(22) Filed: May 24, 2012

Related U.S. Application Data
(63) Continuation of application No. 12/750,629, filed on Mar. 30, 2010, now abandoned.
(60) Provisional application No. 61/164,581, filed on Mar. 30, 2009.

(51) Int. Cl. G06F 17/30; G06F 7/00

(52) U.S. Cl. 707/602; 707/600; 707/E17.005; 707/E17.044

(57) ABSTRACT

An organizational monitoring system is described herein that continuously monitors existing data sources to identify select data to organizational decision makers more quickly. The system may pull information from existing databases and other data sources within an organization, and monitor the information for relevant changes. The system analyses the data to determine events and trends that potentially merit attention of organization leaders. The system provides a rapid organizational information dashboard that decision makers can view on a display device to continuously monitor the organization. Organizational leaders can use the information to make faster business decisions and to get on top of trends that affect the business at an early time when action can be much more effective. Thus, the organizational monitoring system allows faster response to trends and events and more effective management of organizations.

### CROSS-REFERENCE TO RELATED APPLICATIONS

The present application is a continuation of U.S. patent application Ser. No. 12/750,629 (Attorney Docket No. LOCHERER002), entitled “MONITORING ORGANIZATIONAL INFORMATION FOR FAST DECISION MAKING,” and filed on Mar. 30, 2010, which claims priority to U.S. Provisional Patent Application No. 61/164,581 (Attorney Docket No. LOCHERER001), entitled “PROVIDING REAL-TIME ORGANIZATIONAL INFORMATION,” and filed on Mar. 30, 2009, each of which is hereby incorporated by reference.

### BACKGROUND

Large organizations often expend substantial energy on managing the organization. Effective management allows faster growth, identification and entry into new markets, efficient utilization of resources, and many other benefits. Organizations often have employees and/or officers at several levels that perform management tasks. For example, a chief executive officer (CEO) may bear overall responsibility for the organization, but vice presidents of departments such as sales and marketing, engineering, and human resources are responsible for monitoring and overseeing their respective divisions.

The most common way of managing organizations is through reporting. Each division typically generates periodic reports (e.g., weekly, or monthly) based on one or more functions of the division. The reports are delivered to the decision makers for that division to enable division heads to determine what has occurred during the period and to evaluate strategic directions for moving forward. For example, a report may indicate that product development is behind schedule, sales in some markets are doing better than others, spending in a particular group has been higher than usual, and so forth.

Unfortunately, reporting is typically a slow process, and data can be stale by the time it reaches a decision maker with authority to act on the data. For example, by the time data about slow sales reaches a division head, the situation may be much worse. In some cases, the slow sales may be due to an event that the organization could have reacted to more appropriately if the organization leaders found out about the situation sooner. Compounding the problem of reporting not getting any faster, trends are accelerating in pace. With the rise of the Internet, 24-hour sales presence online, and faster forms of media, events affect organizations with unprecedented speed. Measurability is gaining attention in current information technology (IT) systems in efforts to work on this problem. The effort to streamline business operations relies upon reliable information that most organizations have stored in their transactional databases supporting day-to-day operations. Organizations spend considerable effort and time identifying and implementing reporting systems as the basis for their business decisions.

### BRIEF DESCRIPTION OF THE DRAWINGS

FIG. 1 is a block diagram that illustrates components of the organizational monitoring system, in one embodiment.

FIG. 2 is a flow diagram that illustrates processing of the organizational monitoring system to receive configuration information for an organization, in one embodiment.

FIG. 3 is a flow diagram that illustrates processing of the organizational monitoring system to periodically gather organization data, in one embodiment.

FIG. 4 is a flow diagram that illustrates processing of the organizational monitoring system to provide monitored information to decision makers, in one embodiment.

### DETAILED DESCRIPTION

An organizational monitoring system is described herein that continuously monitors existing data sources to identify select data to organizational decision makers more quickly. The system may pull information from existing databases and other data sources within an organization, and monitor the information for relevant changes. For example, the system may periodically poll a sales database to identify sales trends. The system analyses the data to determine events and trends that potentially merit attention of organization leaders. For example, if sales in a particular region have rapidly dropped, the system may identify that region and the falling sales numbers for a decision maker to review. The system provides a real-time or rapid organizational information dashboard that decision makers can place on a large display or other display device in their office or other location to continuously monitor the organization. For example, the system may provide a business ticker display similar to a stock ticker that continuously displays changing information about the business. Organizational leaders can use the information to make faster business decisions and to get on top of trends that affect the business at an early time when action can be much more effective.

Organizations that use the organizational monitoring system can customize the system to track their individually relevant data and to display information that they deem most relevant. For example, an administrator of the system may perform a configuration phase during which the administrator identifies organization data sources and performance indicators that matter to that particular organization. An administrator may identify sales databases, human resources database, research and development databases, customer service database, and so forth that contain ongoing data collected by the organization to perform various functions within the organization. The same information may traditionally served as the source for slower, manual reporting models, but the system extracts the data in an automated way on an on-going basis without further administrator interaction, and reports the data quickly after retrieving it. For example, the system may report on sales just minutes after the sales occur. This fast access to data without unnecessary intermediate processes that slow data collection allows decision makers an unprecedented rate of responsiveness to factors that affect their organization. Thus, the organizational monitoring system allows faster response to trends and events and more effective management of organizations.

In some embodiments, the organizational monitoring system builds a history of tracked information automatically. For example, after polling organization databases for relevant information, the system may store the data in a data store managed by the system. Over time, the data store contains a historical picture of the organization's health and performance. The system can compare historical information to current information to provide additional insights that assist decision makers in making effective decisions. For example, the system can compare this morning's orders with yesterday morning's orders. Going even further back, the system can compare sales today with sales on this day last year. The system can also compare dissimilar data to identify trends that may be useful to decision makers. For example, the system might identify that sales in Japan have just reached an average level of sales in Europe. In some cases, managers may build incentives or specify bonus compensation in terms of achieving specific goals identified or confirmed by the system. Note that in providing this information, the organizational monitoring system has translated items in technical terms to business terms that are useful to organizational leaders. For example, although the system may retrieve data from databases having tables and columns with names selected for ease of engineering (e.g., t_sales_orders, RegionID, and so on), the system can preprocess data to group data from a particular region into a more meaningful number and report that number in business terms such as quantity of sales, average order value, and so forth.

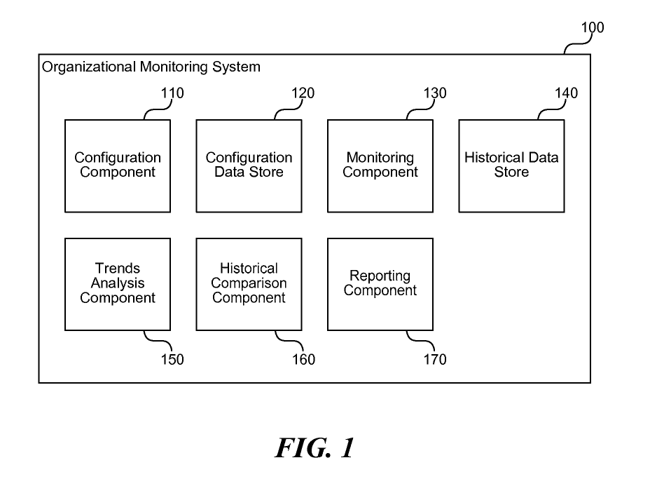

FIG. 1 is a block diagram that illustrates components of the organizational monitoring system, in one embodiment. The system 100 includes a configuration component 110, a configuration data store 120, a monitoring component 130, a historical data store 140, a trends analysis component 150, a historical comparison component 160, and a reporting component 170. Each of these components is described in further detail herein.

The configuration component 110 receives configuration information from an organizational representative that identifies data sources and performance metrics relevant to the organization. For example, an administrator of a corporate IT department may point the system to existing customer and sales data sources and identify meaningful data points within the data sources (e.g., columns that contain sales quantities or currency values). The configuration component 110 may also automatically identify at least some data sources or performance metrics, such as by querying a network for available database servers. In some embodiments, the configuration component 110 provides an administrative dashboard through which the organizational representative can configure setup information and options for the system (e.g., a monitoring interval) on an on-going basis or as new data sources become available. The administrator may also set one or more goals or expectations. For example, organization leaders may expect a particular metric to increase by 2% annually. The system 100 can use this information to compare actual results with expected results and to report when the difference is significant.

The configuration data store 120 stores configuration information related to operation of the system. For example, the configuration data store 120 may include a list of one or more data sources, a monitoring interval, identified performance metrics, a duration to keep retrieved organizational data, access rules for who can view data collected by the system, and so forth. The configuration data store 120 may include one or more hard drives, file systems, databases, cloud-based storage services, storage area networks (SANs) or other facility for persistently storing configuration data.

The monitoring component 130 periodically retrieves organizational information from one or more identified data sources. The monitoring component 130 may run on a regular schedule, such as via an operating system service or daemon process. For example, the monitoring component may wake up every 10 minutes to collect new data related to an organization. An administrator can configure a monitoring interval using the configuration component 110. In some embodiments, the monitoring component 130 may automatically identify a monitoring interval, such as based on historical patterns (e.g., how frequently the data changed in the past day), expected patterns, and so forth. Alternatively or additionally, the monitoring component 130 may monitor different data sources for new information at different intervals. For example, a sales database that provides order history may change much more frequently than a human resources database that provides hiring trends, so the monitoring component 130 may request data from the sales database much more frequently than the human resources database.

The historical data store 140 stores organizational information retrieved by the monitoring component 130. The historical data store 140 may include raw information retrieved from organization data sources as well as results of analysis of past data. The historical data store 140 includes data over time that is consistent even if the original data source goes away or is replaced by another system within the organization. Thus, the historical data store 140 provides a reliable picture over time of organization performance metrics. Like the configuration data store 140, the historical data store may be physically implemented using a variety of available storage facilities. Although illustrated separately, the historical data store 140 and configuration data store 120 may share a common storage facility, such as a database with tables for storing each type of information.

The trends analysis component 150 identifies trends and events in a current batch of data that merit further consideration by organizational decision makers. For example, if sales spike or customer service call volume suddenly increases, the trends analysis component 150 identifies this as an event and provides it to the reporting component 170 for display to one or more users. The trends analysis component 150 stores analysis results in the historical data store 140 so that both raw data and historical conclusions drawn from the data are stored for later use. In some embodiments, the trends analysis component 150 creates a feedback loop in which success or failure of analysis of past trends is used to tune the component 150 to more ably identify future trends and events. For example, if a particular day of the year routinely experiences high sales volume (e.g., Black Friday or Christmas Eve), then the system may determine that sales on such days have to exceed a higher threshold to be identified as noteworthy for reporting purposes.

The historical comparison component 160 determines whether one or more goals have been reached based on comparison of the current batch of data with historical data collected by the system 100. The historical comparison component 160 may provide comparisons as one or more graphs so that a user can visually identify potential decision-altering data. For example, the component 160 may produce a line chart overlaying current call volume with a similar historical period (e.g., just after a product launch, during the same week last year, and so forth). An administrator can set up relevant historical comparisons, so that specific analysis that decision makers want to see is available. Alternatively or additionally, the historical comparison component 160 can automatically determine comparisons that indicate potential trends or similarities that may allow users to view data in a new light or to have insights into data that they would not have discovered independently.

The reporting component 170 provides an interface through which users receive data provided by the system 100. The reporting component 170 provides data in a variety of formats, such as through dynamically generated graphs, presentations, or textual reports. The system may provide output for display on a display device, such as a monitor or television, as well as feeds (e.g., using Really Simple Syndication (RSS)) that can be consumed by a variety of devices. In some embodiments, the component 170 provides a mobile interface that may include a separate client-side application for accessing and monitoring organization data. For example, the system 100 may include a custom application for an Apple iPhone, Google Android-based device, Microsoft Windows Mobile device, or other smart phones or mobile devices for remotely accessing data. In addition, the reporting component 170 may provide an application programming interface (API) through which other systems can access data collected by the systems, such as to integrate the data with other reports or functionality (e.g., to automatically take action upon the occurrence of a specified event). The reporting component 170 may also provide other types of alerts, such as email, text messages, or other notifications that alert organizational decision makers to potentially relevant events. In this way, decision makers are much more connected to the business with constantly up to date information to be able to make more effective business decisions from wherever they are located.

The computing device on which the organizational monitoring system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

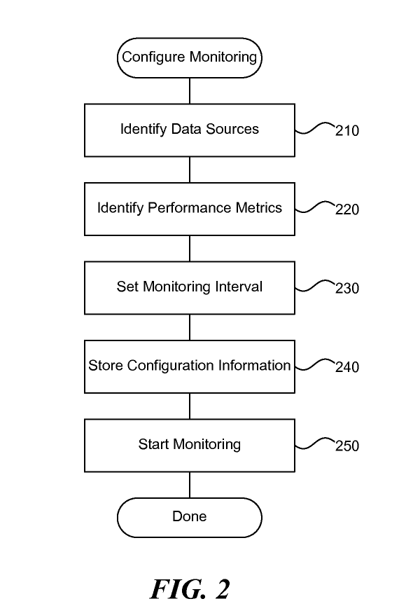

FIG. 2 is a flow diagram that illustrates processing of the organizational monitoring system to receive configuration information for an organization, in one embodiment. Beginning in block 210, the system identifies one or more data sources of an organization that contain recent organizational information. For example, the system may receive input from a user that specifies one or more databases or other sources of information. The data sources may include those used on a daily basis by employees and customers of the company. The data sources provide more recent information than is typically available to organizational leaders.

Continuing in block 220, the system identifies one or more performance metrics that map to the identified data sources. For example, the system may receive input that describes one or more types of information that is available from the data sources and may store the correlation between the data source and the performance metric. In some embodiments, the system may provide a user interface through which non-technical users can identify relevant data, such as a set of checkboxes or other user interface controls, rather than requiring IT personnel to manually write database queries or other scripting. In addition, the system may receive one or more expectations related to the performance metric. For example, the organization may expect a particular metric to grow by 5% per year. The system can measure received data against expectations to identify outlying data that may be of interest to an organizational leader.

Continuing in block 230, the system receives a monitoring interval for the one or more data sources that identifies how frequently to poll the data source for new information. The monitoring interval may be a trade-off between wanting low latency between when new data is stored and when it is consumed by the monitoring system versus potential performance consequences of polling too frequently. The system allows users of the system to control the monitoring interval so that it can be changed based on whether the collected data is provided with sufficient frequency for users.

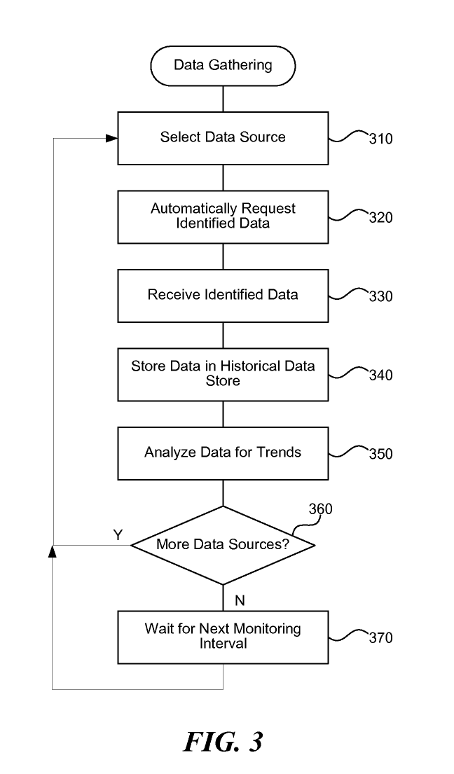

Continuing in block 240, the system stores configuration information based on the identified data sources, performance metrics, and monitoring interval. The system stores configuration data in a configuration data store where the configuration data can be accessed by a monitoring process, like that described with reference to FIG. 3. Administrators or other users may tune the configuration data over time to yield particular results from the system. Continuing in block 250, the system starts monitoring the identified data sources for recent organizational data to present to organizational decision makers. The monitoring process is described further with reference to FIG. 3. After block 250, these steps conclude.

FIG. 3 is a flow diagram that illustrates processing of the organizational monitoring system to periodically gather organization data, in one embodiment. Beginning in block 310, the system selects a data source from which to gather organizational data. The data source may include a transactional database or other data store that an organization uses to conduct business, such as a sales database. The system may iterate through a list of data sources previously identified and stored in a configuration data store. The system periodically monitors each specified data source for new data to be analyzed and reported to organizational decision makers.

Continuing in block 320, the system automatically requests data from the selected data source that has changed subsequent to a previous request for gathering data. For example, the system may execute a query against a database, call a cloud-based storage API, send a Hypertext Transfer Protocol (HTTP) request to a web server, or request other data in any form or using any protocol. Continuing in block 330, the system receives the requested data from the selected data source. For example, if the system issued a database query, then the system receives a query response or an indication that the data cannot be provided (e.g., an error). If the system invoked a storage API, then the API returns the requested data after communication with the data source to retrieve the data. The data may include individual data, such as individual sales of products or received customer support incidents, or aggregate data, such as an average call wait time or a count of orders received.

Continuing in block 340, the system stores the received data in a historical data store of organizational performance information. The historical data store may include another data source on-site within an organization or an external (e.g., cloud-based) service that communicates with servers of the organization to obtain information. The system may store the data in its original form or may preprocess data from a variety of data sources into a common format for storage and subsequent analysis.

Continuing in block 350, the system analyzes received data to identify trends and events that satisfy criteria for reporting to organizational decision makers. For example, the system may identify data peaks or valleys, up-trending or downtrending volume, and so forth. The system may receive criteria, such as department goals, from users or may determine whether particular data exceeds an automatically determined threshold (e.g., really fast growth in a normally flat number) for reporting to users. The system may store analyzed data in the historical data store along with raw information received from various data sources of an organization. Although analysis is shown here after retrieval from each data source, those of ordinary skill in the art will recognize that the order of these steps can be altered to achieve various performance and analytical benefits without deviating from the purpose of the system. For example, the system may perform some analysis after retrieval from each data source and some analysis after data from multiple data sources is available. Likewise, although shown serially, the system may gather data and analyze data in separate processes that run in parallel and at varying intervals.

Continuing in decision block 360, if there are more data sources identified in the configuration data, then the system loops to block 310 to select the next data source, else the system continues at block 370. The system may process a list of data sources or process each data source at a specified interval and only continue processing those data sources due at a current monitoring interval. Continuing in block 370, the system waits for the next monitoring interval, then loops to block 310 to start gathering data from each data source again. For example, the system may wake up every 10 minutes, gather data from each configured data source, and then remain idle until the next 10-minute period. After block 370, these steps conclude.

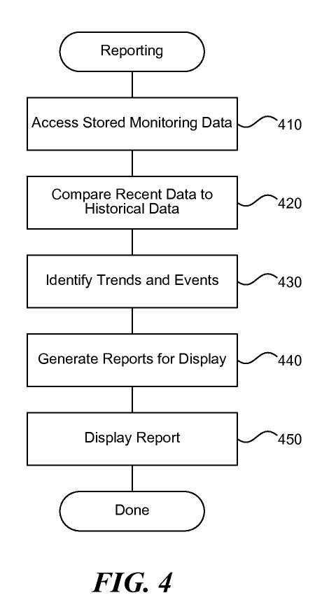

FIG. 4 is a flow diagram that illustrates processing of the organizational monitoring system to provide monitored information to decision makers, in one embodiment. Beginning in block 410, the system accesses stored data gathered from monitoring organizational data sources. For example, the system may access a historical data store that includes performance metrics and analysis related to events within an organization (e.g., with customers or employees).

Continuing in block 420, the system compares recently gathered data to historical data to determine differences between the recently gathered data and historical data. For example, the system may identify that a particular performance metric has increased substantially compared to past measurements of the performance metric. For example, sales in a particular region may have jumped or outage reports may have increased in a manner that warrants additional attention from decision makers.

Continuing in block 430, the system identifies trends and events based on the compared recent data and historical data. For example, the system may identify that sales this year are off pace compared to where they were last year, or a mix of products being sold is more heavily weighted to a department this year that was a poorer performing department last year. In addition, the system may identify events, such as passing a particular performance goal, breaking a performance record (e.g., highest selling day ever), and so forth.

Continuing in block 440, the system generates a report for display to one or more organizational decision makers. For example, the report may include graphs, streaming content, mobile alerts, and so forth that provide information and/or notification to organizational decision makers about relevant identified trends and events. Some organizations may prominently display generated reports, such as on a big screen television in a communal area of the organization (e.g., a lunchroom) or in executives' offices.

Continuing in block 450, the system displays the generated report. For example, the system may provide the report to a mobile client application running on a decision maker's mobile device or to a monitor in the decision maker's office. The system may also provide peripheral information, such as on a computer screen off to the side of a document or other main task that a user is performing. The displayed report provides awareness to decision makers of up to date organizational information through which they can make faster and more effective decisions. After block 450, these steps conclude.

In some embodiments, the organizational monitoring system builds a presentation that can be viewed using presentation software (e.g., Microsoft PowerPoint). Because some organizational decision makers are accustomed to viewing reports through presentation software, the system can dynamically generate presentations in a format selected by users of the system. For example, the system may create charts and graphs and embed them in slides in a dynamically generated presentation. The presentation may be generated at regular intervals based on the most recently available performance metrics gathered by the system. In addition, the presentation can be used to present a glimpse of organizational performance to other parties, such as investors in the organization.

In some embodiments, the organizational monitoring system provides streaming information like a stock ticker. Rather than stocks, the system displays selected or automatically identified business performance metrics. For example, the system may display current daily sales by volume or value in each of multiple regions in which an organization sells products. The system can continuously stream various potentially interesting data points that organizational decision makers can glance at during idle time or while performing other activities to stay aware of how the organization is doing and to learn about potentially significant events that merit attention.

In some embodiments, the organizational monitoring system identifies potentially interesting information automatically. For example, the system can use machine algorithms well known to those of ordinary skill in the art to identify peaks, sustained growth, outlying performance indicators, and so forth. The system can use trending tools to identify trends, identify outlying information, and spot potential disruptions in expected behavior. For example, if a particular region is experiencing low sales, then the system may spot that the sales volume is lower than historical trends and report this information to a decision maker that can take action to discover the cause and provide a remedy.

In some embodiments, the organizational monitoring system is hosted as a cloud-based service that multiple organizations can access to provide organizational reporting as a service. The system may maintain accounts for each customer organization and allow subscriptions or other revenue models for providing the service to the organizations. Although the system can also be implemented as an in-house data mart, IT personnel of organizations have recently been trending towards allowing outside management of certain systems to reduce the internal overhead of training and support related to a wide variety of systems.

In some embodiments, the organizational monitoring system provides a connector to third-party software and/or services that enhance the experience of using the system. For example, the system may provide a SalesForce.com connector through which an organization can connect to data used by sales professionals within the organization. The system may receive data from the connector that enhances the system's own reporting and provide data to the connector for the third-party application's use. For example, SalesForce.com provides sales data and a metadata layer that obviates writing queries to access organizational information. Instead, a user of the system can select potentially interesting data through combo boxes and other common user interface paradigms that do not involve sophisticated technical knowledge.

In some embodiments, the organizational monitoring system provides multiple streams of data. These streams of data are analogous to channels on a television and may each be used by different departments or for other purposes within an organization. For example, the system may provide different reporting to department heads and a CEO. Alternatively or additionally, the system may provide multiple channels to a single user, such as the CEO, so that the CEO can flip through analysis related to different departments or functions of the organization. The system may receive configuration information from users that indicates channels of data that the users want to be able to view and that the system will collect and analyze to populate the channels or data streams. In some installations, a particular user may have multiple monitors or displays that each provides an on-going display of a different stream of information.

From the foregoing, it will be appreciated that specific embodiments of the organizational monitoring system have been described herein for purposes of illustration, but that various modifications may be made without deviating from the spirit and scope of the invention. Accordingly, the invention is not limited except as by the appended claims.

I/We claim:

1. A computer-implemented method for automatic gathering of organizational performance information, the method comprising:
selecting a data source from which to gather organizational data;
automatically requesting data from the selected data source that has changed subsequent to a previous request for gathering data;
receiving the requested data from the selected data source;
storing the received data in a historical data store of organizational performance information; and
analyzing received data to identify trends and events that satisfy criteria for reporting to organizational decision makers,
wherein the preceding steps are performed by at least one processor.

2. The method of claim 1 wherein selecting the data source comprises selecting a transactional database that an organization uses to conduct business.

3. The method of claim 1 wherein selecting the data source comprises selecting a data source from a list of data sources previously identified and stored in a configuration data store.

4. The method of claim 1 wherein automatically requesting data comprises retrieving organizational performance data without administrator interaction.

5. The method of claim 1 wherein automatically requesting data comprises executing an automatically defined query to extract data from an organizational database.

6. The method of claim 1 wherein receiving the requested data comprises aggregate data comprising information grouped from multiple original data entries.

7. The method of claim 1 wherein storing the received data comprises storing the data in a data store on-site within an organization.

8. The method of claim 1 wherein storing the received data comprises storing the data in a data store hosted externally as an online service.

9. The method of claim 1 wherein identifying trends and events comprises using trend analysis tools to identify data peaks and valleys.

10. The method of claim 1 wherein the criteria include received goals from one or more users of the system.

11. The method of claim 1 wherein satisfying criteria includes determining whether particular data exceeds an automatically determined threshold for reporting to users.

12. The method of claim 1 wherein analyzing received data comprises automatically identifying outlying current information compared to historically gathered information.

13. The method of claim 1 further comprising repeating the previous steps at the expiration of a configured monitoring interval.

14. A computer system for providing rapidly updating organization information to decision makers, the system comprising:
a processor and memory configured to execute software instructions;
a configuration component configured to receive configuration information from an organizational representative that identifies data sources and performance metrics relevant to the organization;
a configuration data store configured to store configuration information related to operation of the system;
a monitoring component configured to periodically retrieve organizational information from one or more identified data sources;
a historical data store configured to store organizational information retrieved by the monitoring component;
a trends analysis component configured to identify trends and events in a current batch of data that potentially merit further consideration by organizational decision makers;
a historical comparison component configured to determine whether one or more organizational goals have been reached based on comparison of the current batch of data with historical data collected by the system;
a reporting component configured to provide an interface through which users receive data provided by the system.

15. The system of claim 14 wherein the configuration component is further configured to automatically identify at least some data sources or performance metrics.

16. The system of claim 14 wherein the configuration component is further configured to receive one or more organizational goals related to at least one performance metric.

17. The system of claim 14 wherein the monitoring component is further configured to gather data upon each expiration of a determined monitoring interval.

18. The system of claim 14 wherein the monitoring component is further configured to automatically determine an interval for monitoring organizational data based on a historical rate of change of previously gathered data.

19. A computer-readable storage medium comprising instructions for controlling a computer system to report fast changing organizational information, wherein the instructions, when executed, cause a processor to perform actions comprising:
accessing stored data gathered from monitoring organizational data sources;
comparing recently gathered data to historical data to determine differences between the recently gathered data and historical data;
identifying trends and events based on the compared recent data and historical data;
generating a report for display to one or more organizational decision makers;
displaying the generated report to at least one organizational decision maker within a short period relative to a time the data was gathered, wherein the displayed report provides awareness to decision makers of up to date organizational information through which they can make faster and more effective decisions.

20. The medium of claim 19 further comprising generating at least one additional report that includes a different stream of data partitioned according to a division relevant to the organization.
